(19) United States
(12) Patent Application Publication
(10) Pub. No.: US 2011/0259158 A1
(43) Pub. Date: Oct. 27, 2011

(54) Dual Hex Pattern Wrench

(76) Inventor: Perry James Richardson, Los Gatos, CA (US)

(21) Appl. No.: 12/960,516

(22) Filed: Dec. 5, 2010

Related U.S. Application Data
(60) Provisional application No. 61/327,708, filed on Apr. 25, 2010.
(60) Provisional application No. 61/349,811, filed on May 28, 2010.

(51) Int. Cl. B25B 13/06

(52) U.S. Cl. 81/124.4

(57) ABSTRACT

A socket wrench incorporating both English (inch) and Metric sizes. Two conventional single-size sockets are replaced by a dual-size hex pattern socket, reducing the number of sockets likely to be needed to do a job. One hex pattern is sized to match preferably a Metric component and the other hex pattern is sized to match preferably an English component. The two different sized hex patterns are preferably offset by 30 degrees.

This application claims the benefits of U.S. Provisional Application No. 61/327,708 filed on Apr. 25, 2010 and of U.S. Provisional Application No. 61/349,811 filed on May 28, 2010.

### BACKGROUND OF THE INVENTION

1. Technical Field

The present invention relates generally to hand tools, and more particularly to socket or box wrenches.

2. Discussion of Prior Art

Conventional wrenches for turning a hexagonal nut have faces to bear on each of the six sides of the nut. FIG. 1 illustrates a typical prior art hexagonal socket wrench 10, having a handle 12 and a detachable socket 14. Socket 14 contacts and applies force to the surface around most of the periphery of a hexagonal nut. For applications not requiring a wrench to contact as much of the surface of a nut, hexagonal wrenches as shown in FIG. 2 have been modified to form a second hexagonal opening having corners extending into the midpoints of the sides of the first hexagonal opening. Since a correspondingly sized hex nut will fit into either of the two sets of hexagon corners this “dual hex configuration” doubles the number of, and makes it easier to find, positions at which the wrench can be placed on the nut. These are typically called “12 point sockets.”

Automobiles often are assembled from components that are manufactured in many different countries. Some countries utilize the inch system and others the metric system. Many machines are assembled with both Metric and English sized nuts and bolts. A conventional hand driven inch or metric sized socket is made to fit only one specific size nut or bolt. This has obliged mechanics, machinists, electricians and consumers to purchase a large number of individual single-ended sockets to make up a tool set that will accommodate different jobs with inch and metric hardware.

Some commercial hand tools have combined opposite ends specifically designed for engaging different sizes of inch or metric nuts and bolts, such as: open-end and box-end wrenches; flex-box wrenches, standard and offset ratcheting box-end wrenches and open-end/socket-end wrenches. These tools are available in various combinations of sizes to engage more than one size fitting of nut or bolt. FIG. 3 illustrates a prior art double-ended box wrench for bolts of a first size at one end and of a second size at the other end.

U.S. Pat. No. 5,048,379 shows double-ended sockets with an internal axially central square drive well, accessible from either open socket end by a conventional extension rod for driving the tools. However, this patent requires the removal, rotation, and replacement of the socket to change from inch to metric size. Also, this patent requires an extension or a special driving wrench to operate.

In addition to the large number of wrench sizes used, mechanics or other persons proceeding to install or remove nuts or bolts are often uncertain of the precise size and, by eyeballing the nut, guess which size wrench to use. Further, when servicing an automobile it is often difficult to determine whether a bolt is inch or metric. Commonly, the mechanic needs to try sockets until he or she discovers the correct sized socket for the bolt or nut of interest. It may take a few tries to discover whether the bolt is metric or inch, and the size required. If they choose wrongly and their choice is smaller the wrench will of course not fit. If their wrong choice is larger but not too much the wrench will fit loosely as shown in FIG. 4, in which a 17 mm Metric size (0.669″) nut NS is mismatched with an 11/16 inch English size (0.688″) wrench opening H1=H2. Since the large wrench hex opening H1 (face-to-face diameter) is 0.019″ more than the small nut NS size HSs, when the wrench is turned (e.g., counterclockwise) it does not engage the nut NS until the wrench vertices have rotated slightly beyond the nut vertices and then only the vertices as at point P (rather than substantial areas of the faces) of the nut NS contact the faces of opening H1 of the wrench. If both the wrench and the nut are made of material that is hard enough to withstand the application of applied turning forces then this will turn the nut, but if either material (usually the nut) is not strong enough, then there is an increased chance that this mismatch will round off the vertices of, and ruin, (usually) the nut.

### SUMMARY OF THE INVENTION

The present invention provides a socket that accommodates two sizes of bolts to reduce the total number of sockets required for assembly and disassembly of various sizes nuts and bolts. Sockets configured according to the invention reduce the time required to determine the correct sized socket for a particular nut or bolt.

Standard English sizes of wrenches considered alone are spaced apart far enough to limit opportunities for making an inner hex pattern of the next smaller size than an outer pattern. Standard Metric sizes of wrenches are spaced similarly far apart. However, considering the range of English sizes side-by-side with the range of Metric sizes, there are numerous instances of English and Metric sizes that are only slightly different. This is a very cause of confusion over correct sizes as discussed in the Background section. The present invention teaches taking advantage of the fact that a 12 point, double hex wrench socket could accommodate two slightly different nut sizes. One of the hex patterns could be sized to match a metric component and the other hex pattern sized to match an inch component. These two different sized hex patterns enable the user to use one socket for the two sizes of hexagonal nuts.

The present invention in a preferred embodiment includes a wrench for turning hexagonal nuts and bolts, having a socket with a center axis and, around the axis, a cylindrical opening which, in a plane perpendicular to the axis, has sides along the greater of the perimeter of a first hexagon and the perimeter of a second hexagon which is offset around the axis from the first hexagon.

Among the advantages of the invention is that the dual function socket reduces the number of times a user has to change tools and thereby allows faster repairs.

### BRIEF DESCRIPTION OF THE DRAWING

FIG. 1 is an isometric view of a prior art socket wrench handle and detachable hexagonal socket;

FIG. 2 is a cross section of a prior art double hex socket;

FIG. 3 is a plan view of a prior art double ended, double hex, closed box wrench;

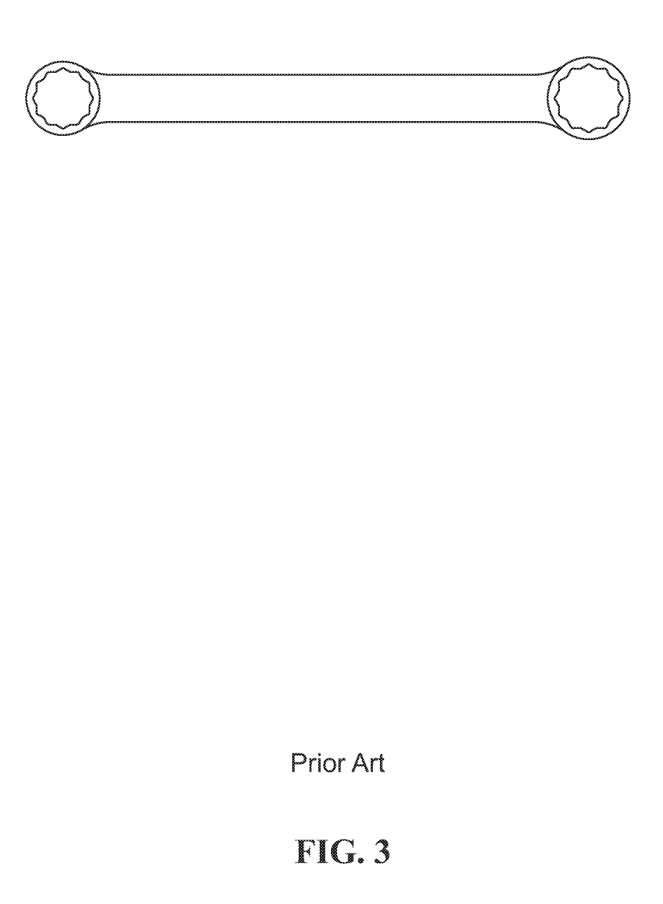

FIG. 4 is an end view of a prior art socket as in FIG. 3 in an English 11/16″ size used with a mis-matched smaller Metric 17 millimeter nut;

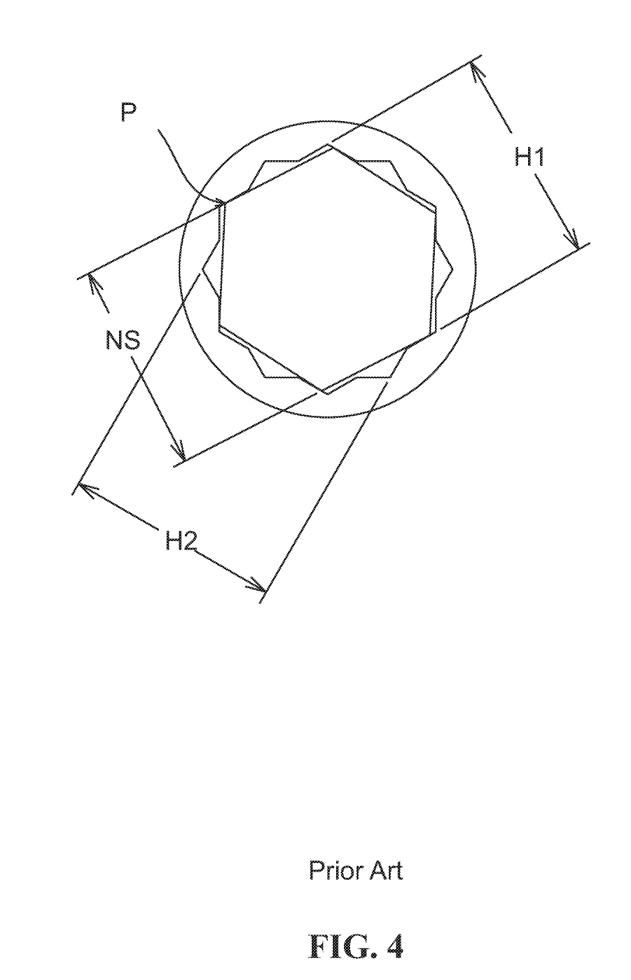

FIG. 5 is an isometric view of a dual-size double hex socket according to an embodiment of the present invention;

FIG. 6 is an end view of the dual-size hex socket of FIG. 5, identifying features of two different size outer and inner hex patterns;

FIG. 7 is an end view of the FIG. 6 socket identifying dimensions of the two different size large and small hex patterns;

FIG. 8 is a table listing, in Column A English sizes in fractions of an inch for an outer hex pattern, in Column D Metric sizes under consideration for an inner hex pattern, and in Column J indicating with a check mark if the combination is preferred;

FIG. 9 is a table listing, in Column A Metric sizes for an outer hex pattern, in Column D English sizes under consideration for an inner hex pattern, and in Column J indicating with a check mark if the combination is preferred;

FIG. 10 is a table similar to FIG. 8 but evaluating maximum and minimum size English sizes for an inner hex pattern;

FIG. 11 is a table similar to FIG. 9 but evaluating maximum and minimum size Metric sizes for an inner hex pattern;

FIG. 12 is an end view of a dual-size double hex socket according the invention having an outer hex size H1= 11/16″ and an inner hex size H2=17 mm, used with the 11/16″ hex size mismatched to a 17 mm nut as in FIG. 4, but with increased surface contact area;

FIG. 13 is a diagram showing the theoretical limit for the reduction in size for an inner hex pattern; and

FIG. 14 is a plan view of a double ended, double hex, closed box wrench capable of engaging nuts or bolts of four different sizes.

### DETAILED DESCRIPTION OF THE INVENTION

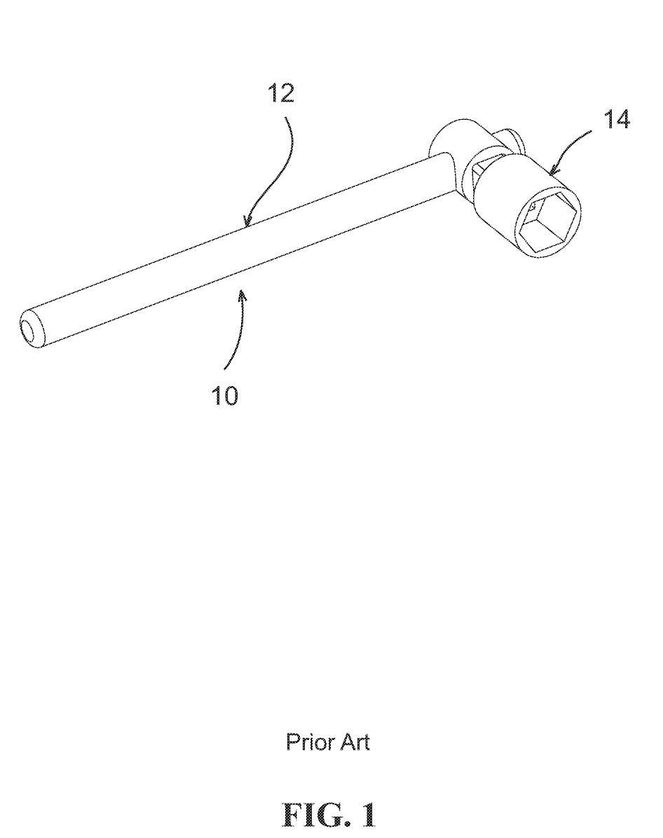

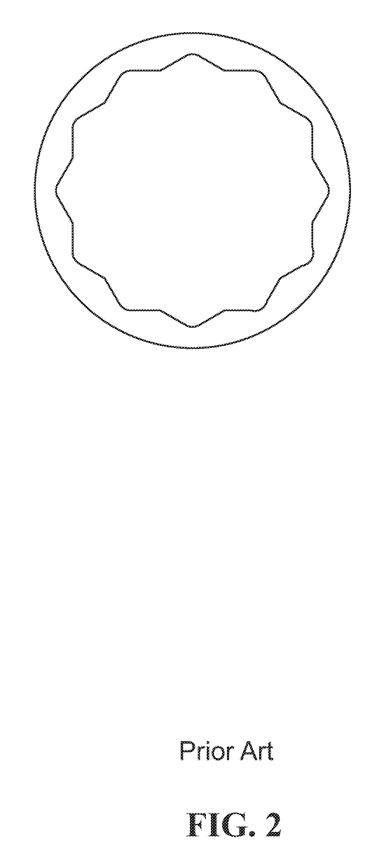

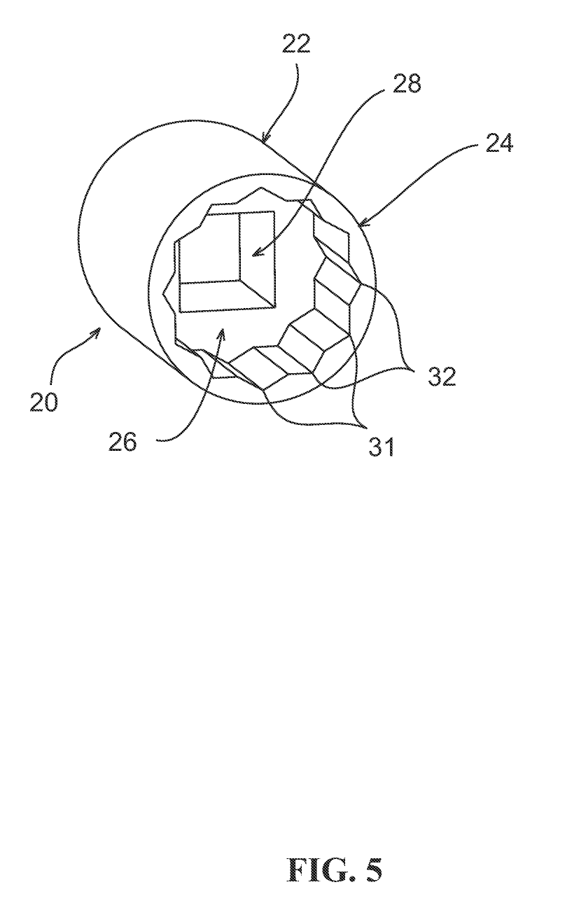

FIG. 5 is an isometric view of a wrench socket 20 according to an embodiment of the invention. The socket 20 comprises a body 22 having an outside surface with a preferably generally cylindrical shape, although other shapes are possible. The socket body 22 has a front end 24 with a nut opening 26. An embodiment as a detachable socket body has a back end (not visible) with a coupling, for example a square drive pocket 28 or other aperture, for mounting on a wrench handle similar to the handle 12 shown in FIG. 1. The wrench handle delivers torque through the coupling to the socket body 22 and then to the outer hex pockets 31 and inner hex pockets 32. Other types and shapes of drive pockets could be used to provide the torque to the socket body. An alternate embodiment as a non-detachable socket such as a box wrench similar to the prior art wrench shown in FIG. 2, rather than having a coupling, is formed integrally with a handle.

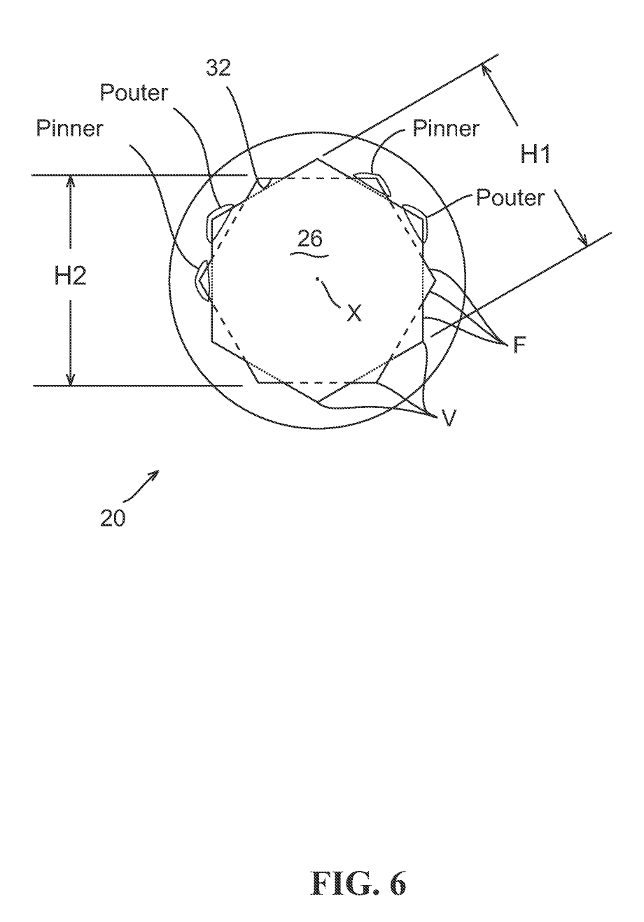

As shown in FIG. 6 the nut opening 26 is centered around a rotational axis X of the socket 20 and bounded by an inside surface 32 having preferably 24 facets F in planes parallel to the axis. Adjacent facets intersect in alternately positive (CW 60°) and negative (CCW 30°) angles. Each positive angle vertex V and its adjacent facets form a pocket P. A first set of pockets Pouter including every other pocket defines the boundaries of a first hexagonal pattern H1 (pockets connected by dashes). A second set Pinner of the alternate pockets defines the boundaries of a second hexagonal pattern H2 (pockets connected by dots). In a conventional single-size socket wrench the two hexagonal patterns are of equal sizes and offset by 30° around axis X; in a wrench according to the invention the two hexagonal patterns H1 and H2 are of different sizes to accommodate different sized nuts.

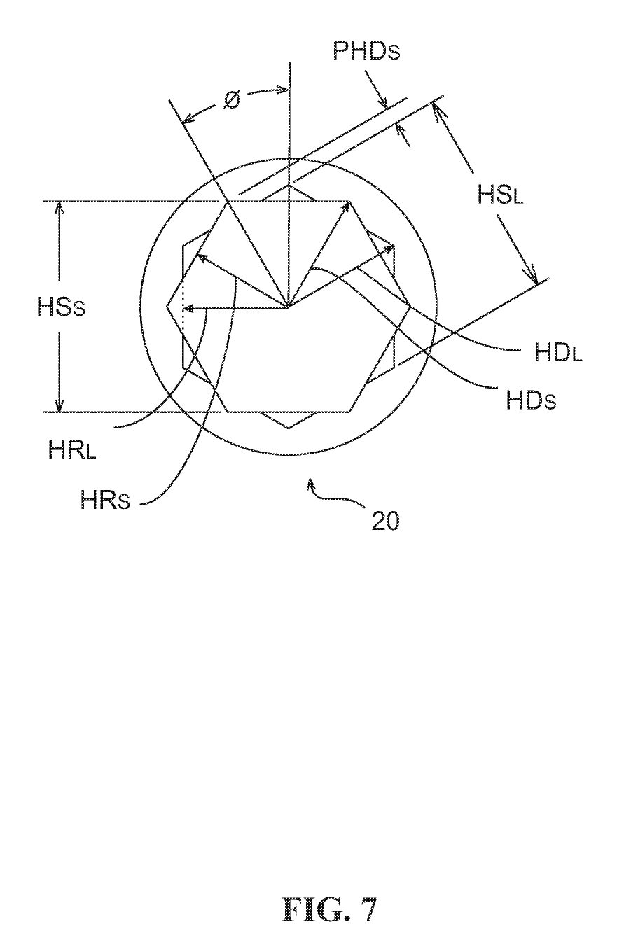

FIG. 7 identifies dimensions of a larger, outer, first hex size HSL and a smaller, inner, second hex size HSs in a socket 20 according to an embodiment of the invention. The two hex patterns are preferably offset by ø=30° around axis X.

Large Hex pattern

Hex Size Large=HSL

Hex Radius Large=HRL

Hex Diagonal Large=HDL

Point Hex Distance Large=PHDL (not shown)

Small Hex pattern

Hex Size Small=HSs

Hex Radius Small=HRs

Hex Diagonal Small=HDs

Point Hex Distance Small=PHDs

The nominal sizes of the accommodated hex nuts, larger hex size HSL and smaller hex size HSs, yield further dimensions as follows:

The Hex Radius HR is half the overall Hex Size HS (i.e., face-to-face diameter).

HR=½*HS

For each pattern the Point-to-Hex Distance PHD is that pattern's Hex Diagonal HD minus the alternate pattern's Hex Radius HR:

For the larger, outer hex pattern H1;

HDL=HRL/cos 30°

PHDL=HDL−HRs

For the smaller, inner hex pattern H2;

HDs=HRs/cos 30°

PHDs=HDs−HRL

The Surface Contact lengths for the large and small hex sizes are:

SCL=PHDL/sin 30°

SCs=PHDs/sin 30°

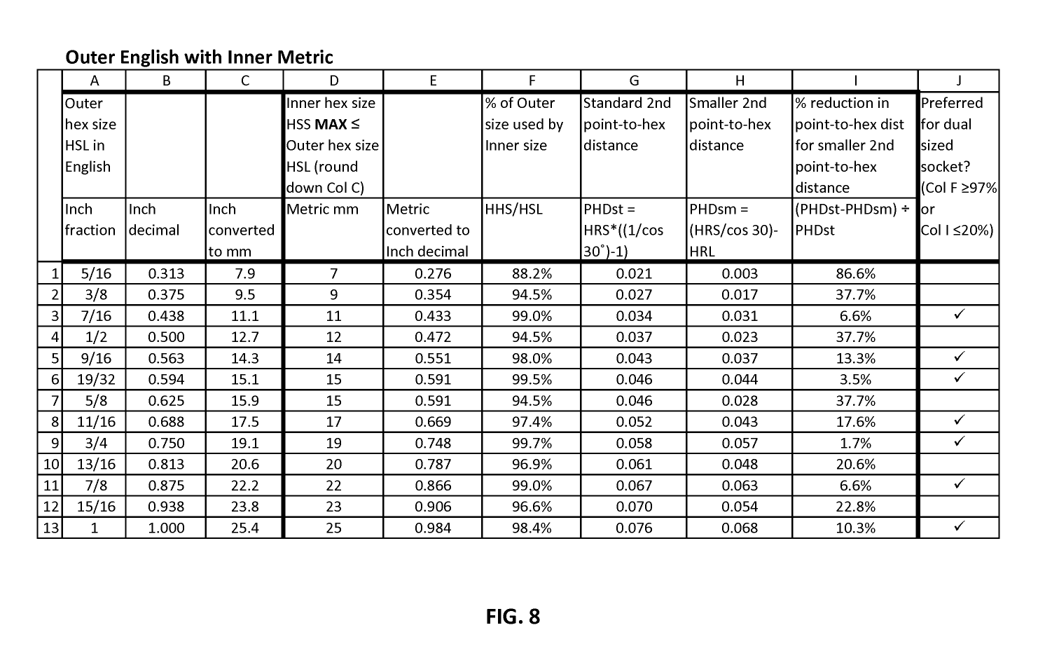

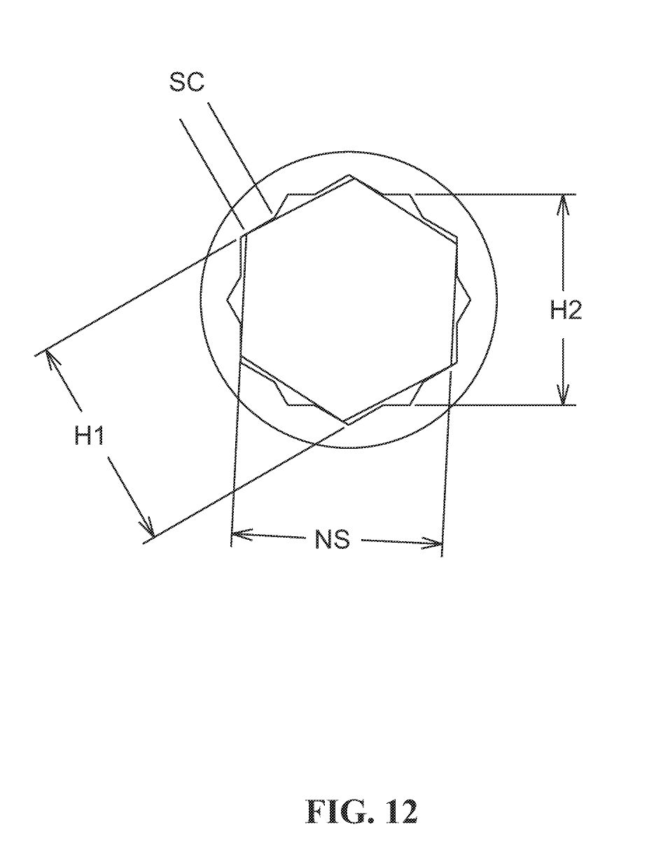

The above dimensions determine what different wrench sizes can be advantageously combined in dual sized wrenches according to the invention. The surface contact areas of facets F of a dual hex socket wrench need to be large enough to adequately grip and turn a hex nut, and the pockets deep enough not to round the nut vertices. Reducing the hex size HSs of an inner hex pattern reduces its point-to-hex distance PHDs and correspondingly its surface contact length and hence, surface contact area. (Conversely, reducing the hex size HSs of an inner hex pattern increases the outer hex pattern's point-to-hex distance PHDL and correspondingly its surface contact area, as discussed below with reference to FIG. 12.) Preferably, an inner hex pattern H2 preserves at least 80% of the surface contact area of an equal size hex pattern in a standard one size dual hex wrench. In other words, the reduction in point-to-hex distance shown in Column I of FIGS. 8, 9, 10 and 11 preferably does not exceed 20%. An alternate calculation for the minimum preferred practical size HSs of an inner hex pattern is that it preferably use at least 97% of the outer hex size HSL as shown in Column F of FIGS. 8, 9, 10 and 11.

FIG. 8 Column A lists English sizes considered for use as the larger hex pattern with a Column D Metric size for the smaller hex pattern in a dual size wrench, and Column J indicates with check marks the combinations of sizes that are suitable. For example, the two similar wrench sizes 11/16 inch and 17 mm are considered in FIG. 8, row 8. The English size 11/16″(Col. A) is equal to 0.688″ (Col. B) while the Metric size 17 mm (Col. D) is equal to 0.669″ (Col. E). 11/16″ is larger so it becomes the outer hex size HSL (Col. A) while 17 mm becomes the inner hex size HSs (Col. D). Applying the above formulas, Inner size HSs uses 97.4% (Col. F) of Outer size HSL, satisfying the 97% preferred minimum and meaning that the Row 8 sizes 11/16 inch and 17 mm are suitable to be combined in a dual sized wrench according to an embodiment of the invention, as indicated by the check mark in Row 8 Column J.

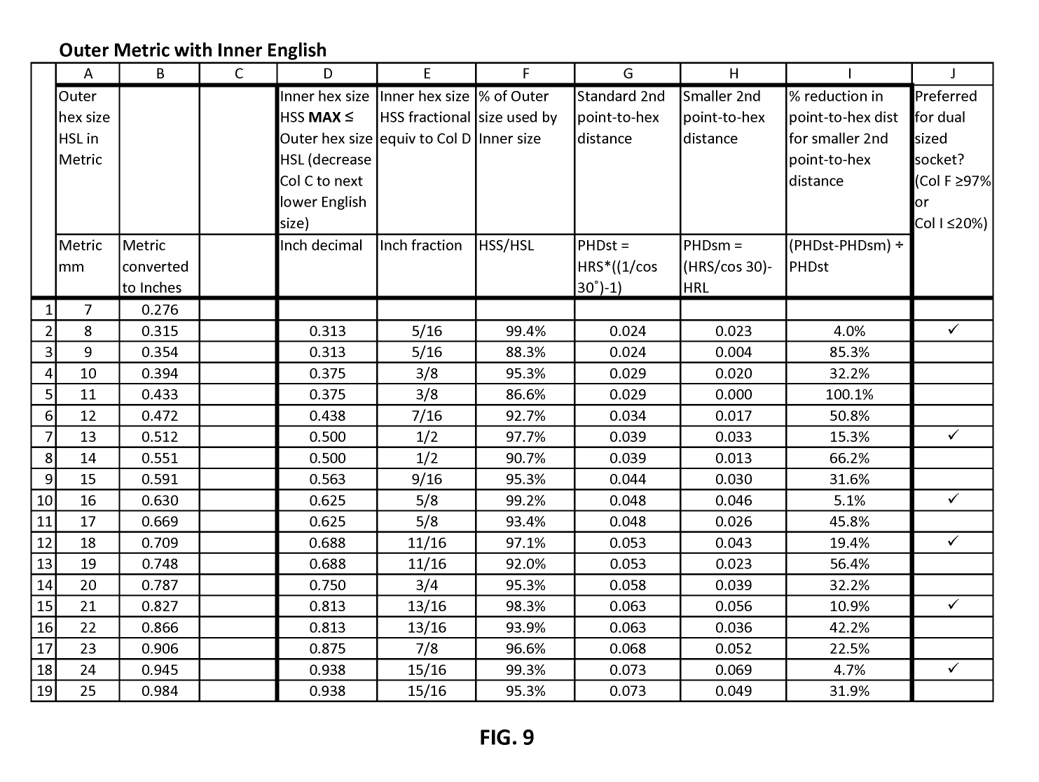

FIG. 9 Column A lists Metric sizes considered for use as the larger hex pattern with a Column D English size for the smaller hex pattern in a dual size wrench, while Column J indicates with check marks which combinations of sizes are suitable. For example, referring to FIG. 9 row 7, an outer, first hex pattern H1 may have a width HSL of 13 mm (Col. A) while an inner, second hex pocket H2 has a width HSs of ½″ (Col. E). 13 mm equals 0.512″ (Col. B) so a ½ inch hexagon is only slightly, 0.012″, smaller. The first set of hex pockets is used to turn a 13 mm bolt or nut. The second set of hex pockets is used to turn a ½″ bolt or nut.

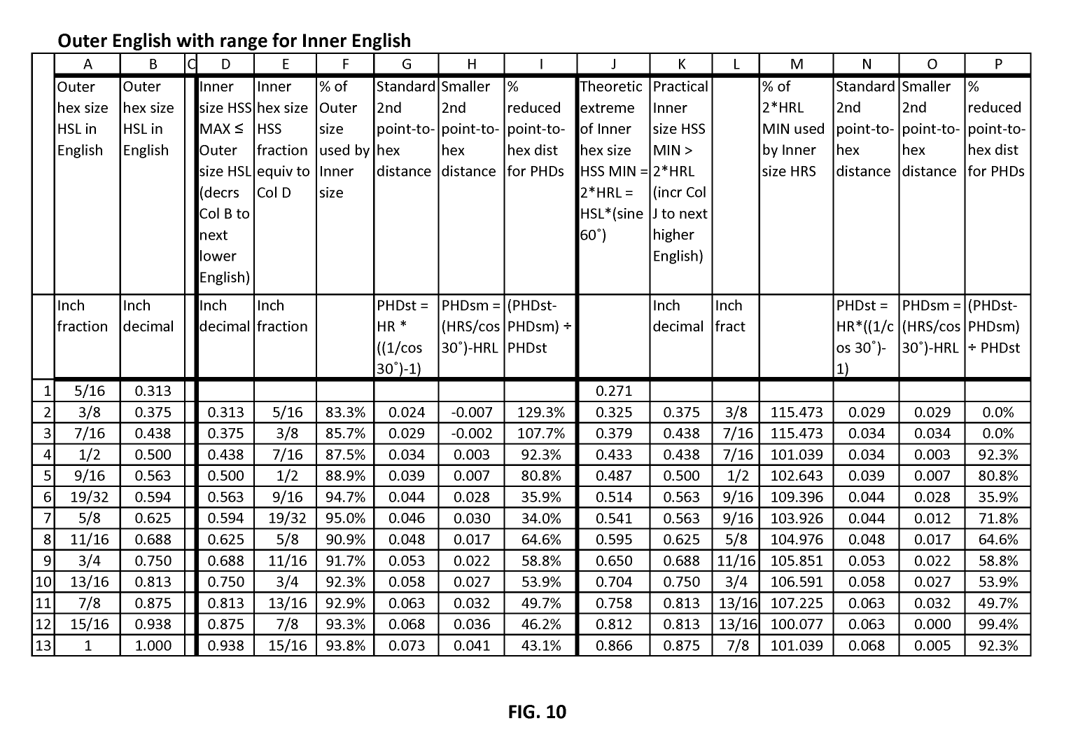

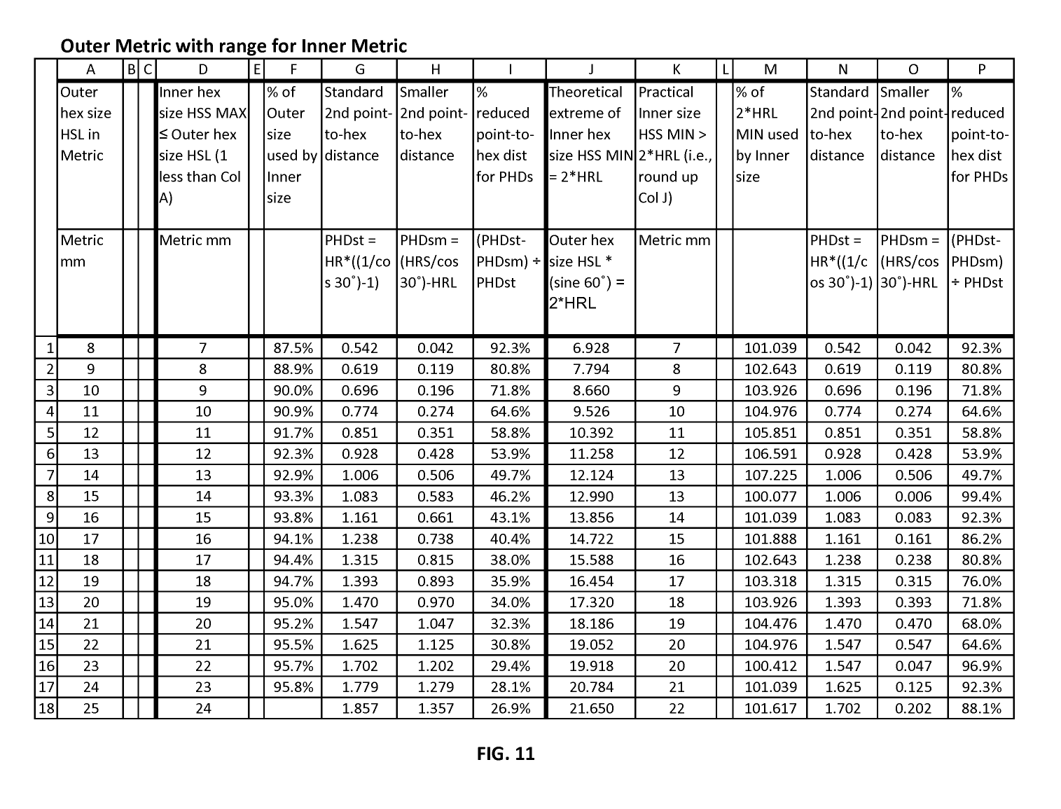

Further, as shown in the tables of FIGS. 10 and 11, two sets of hex pockets could be of two closely spaced English (inch) sizes or two closely spaced Metric sizes. FIGS. 10 and 11 do not indicate any possible combinations of English/English or Metric/Metric sizes yielding at least 97% in Column F or at most 20% in Column P. The difference between 1 1/16 inch and 1⅛ inch sockets is slight. English/English and Metric/Metric combinations become more practical on larger sockets.

As mentioned above, as the inner hex pattern size HSs decreases, the outer hex pattern's point-to-hex distance PHDL, and correspondingly its surface contact length SCL and area, increases beyond the standard first point-to-hex distance HRL. Therefore, as the inner hex H2 gets smaller the gripping ability of the wrench's outer hex H1 gets stronger. Consequently, as shown in FIG. 12 the increased Surface Contact (SC) area of the outer pattern H1 is better even for a mismatched Nut Size NS=17 mm than is a conventional single sized ( 11/16″) wrench for a mismatch. The strength of the hex pockets is maximized if the two sets of pockets are offset by 30° around axis X, but other offsets are possible.

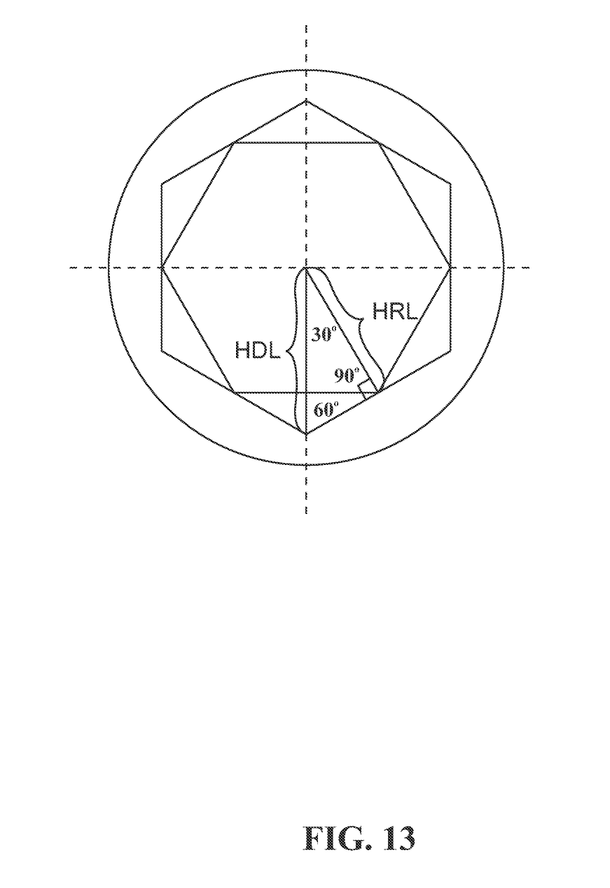

If harder materials were used to fabricate nuts, bolts and socket wrenches, then the preferred limits of no more than 20% reduction in point-to-hex distance, or that the inner hex size HSs be at least 97% if the outer hex size HSL, might be exceeded to consider dual sizes such as those listed in FIG. 10 rows 7, 12 and 13, and in FIG. 11 rows 8-18. Referring to FIG. 13, the maximum theoretical difference between outer and inner sizes, or the minimum theoretical size of the inner hex pattern, is for the inner hex pattern diagonal HDs to be at least the outer hex pattern radius HRL. HRL is equal to HDL times sine 60°. This extreme of (HDL)*(86.6%) is only approached when the offset between the two hex patterns is 30° around axis X.

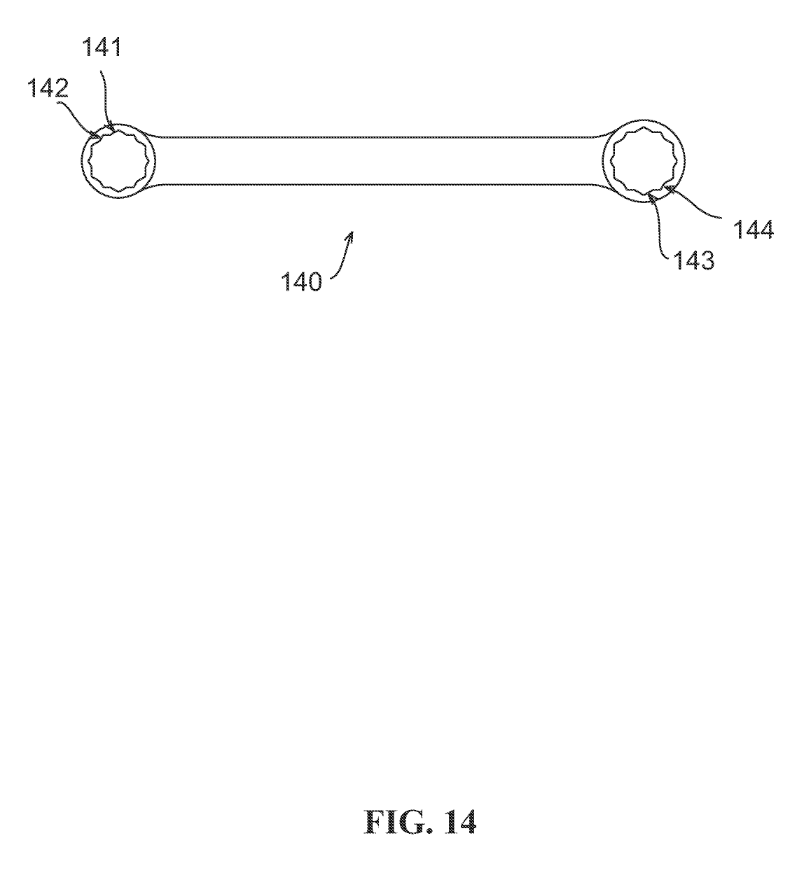

FIG. 14 shows the invention in an embodiment as a double ended, double hex, closed box wrench 140 capable of engaging nuts or bolts of four different sizes. One end of wrench 140 has dual hex patterns 141 and 142 for use on first and second sizes. The other end has dual hex patterns 143 and 144 for use on third and fourth sizes.

While the present invention is described in terms of preferred embodiments, it will be appreciated by those skilled in the art that these embodiments may be modified without departing from the essence of the invention. For example, the principles of the invention could be applied to square-headed nuts and bolts by using offset outer and inner sets of square patterns. It is therefore intended that the following claims be interpreted as covering any modifications falling within the true spirit and scope of the invention.

I claim:

1. A wrench for turning hexagonal nuts and bolts, having a socket formed to fit a first hex nut of a first size, at a different time, a second hex nut of a different second size.

2. The wrench of claim 1 wherein, of the first and second sizes, one is an English measurement and the other is a Metric measurement.

3. The wrench of claim 1 wherein the first and second sizes are English measurements of different sizes.

4. The wrench of claim 1 wherein the first and second sizes are Metric measurements of different sizes.

5. A wrench for turning hexagonal nuts and bolts, having a socket with a center axis and, around the axis, a cylindrical opening which, in a plane perpendicular to the axis, has sides along the greater of the perimeter of a first hexagon and the perimeter of a second hexagon which is offset around the axis from the first hexagon.

6. The wrench of claim 5 wherein the second hexagon is offset by 30 degrees around the axis from the first hexagon.

7. The wrench of claim 6 wherein the first hexagon has opposing faces at a distance HSL and the second hexagon has opposing faces at a distance HSs which is greater than sine 60° times HSL.

8. The wrench of claim 7 wherein distance HSs is at least 97% of distance HSL.

9. The wrench of claim 7 wherein the reduction in Point-to-Hex distance PHDs for the second hexagon pattern compared to a hexagon pattern of the same size HSs in a single size wrench is ≦20%.

10. A socket tool that has, rotationally offset from each other, one square opening sized to metric dimensions and another square opening sized to inch dimensions.
